(19) United States
(12) Patent Application Publication
(10) Pub. No.: US 2016/0343090 A1
(43) Pub. Date: Nov. 24, 2016

(54) Resource Flow Interface

(71) Applicant: Caterpillar of Australia Ply. Ltd., Tullamarine (AU)

(72) Inventors: Gregory Wood, Queensland (AU); Thomas Doherty, Queensland (AU); Veronica Jericho, Queensland (AU); Glen Blanchard, Queensland (AU)

(73) Assignee: Caterpillar of Australia Ply. Ltd., Tullamarine (AU)

(21) Appl. No.: 15/154,438

(22) Filed: May 13, 2016

(30) Foreign Application Priority Data
May 20, 2015 (AU) 2015202736

(51) Int. Cl. G06Q 50/02; G06Q 10/06; H04L 12/26

(52) U.S. Cl. CPC G06Q 50/02; H04L 43/045; G06Q 10/06312

(57) ABSTRACT

There is provided a computer implemented method for generating a deviation resource flow interface on a computer system display. For planned flows of resources, information is obtained on planned resource transfers between nodes. Similarly, for actual flows of resources, information is obtained on performed transfers of at least some of the same resources between the nodes. This information is aggregated and flow statuses determined for the aggregated resource transfers. A deviation from plan status is assigned to a transfer if it is determined that a planned transfer has not been performed or if it is determined that a performed transfer does not conform to a planned transfer. If it is determined that a performed transfer conforms to a planned transfer, an on-plan flow status is assigned to such transfer. The aggregated planned and performed flows are then used to generate and display a resource flow diagram which comprises one or more distinct weighted links between various nodes, wherein each of the weighted links is indicative of resource flow with a flow status indicating whether the flow is a deviation from the planned transfers or not.

### TECHNICAL FIELD

The present disclosure relates to systems and methods for generating and displaying a resource flow interface on an electronic device. In particular, the present disclosure relates to systems and methods for generating and displaying a deviation flow interface for resources such as mining materials.

### BACKGROUND

In a mining environment, various plans are put in place to manage operations throughout are mine. For example, typically short term plans are in place to manage the flow of material being excavated. Such plans would typically include projected volumes (or weight) of material to be excavated and moved from various excavation sites to various destination locations, such as processing sites or dumps. The plans are usually detailed enough to allocate particular excavation and transfer operations (in terms of material and weight) to particular pieces of mining equipment. Management of this type of flow of materials on a continuous basis is desirable, as exceptions or unplanned events may have a serious knock-on effect on other mining operations, or the utilisation of resources.

For example, if one of the excavation vehicles has a breakdown, the planned excavation and haulage may not be achievable without plan being adjusted (e.g., some equipment increasing their output). The same applies to scenarios where haulage (or loading) of material is delayed. On the other hand, if material is excavated at a rate exceeding the planned rate, i.e. ahead of schedule, destination locations may exceed their maximum capacity resulting in no additional off-loading being authorised. Again, this may have a knock-on effect as operations may be halted as a result.

Another unforseen circumstance may be when there is a discrepancy between the planned material to be excavated at a particular location and the type of material excavated. For example, the mining plan may stipulate that a particular piece of mining equipment is to excavate and transfer ore, while the area of excavation delivers not only ore, but also unplanned materials.

Present systems allow for detailed reporting of mining activities on a periodic basis, e.g., after the completion of a shift. However, this type of after the fact reporting is problematic as mining operators are unable to make adjustments to counter exceptions experienced on an ongoing basis within the mining environment.

It would accordingly be desirable to provide a material flow interface for an computer system which represents material flow information on a more ongoing basis and/or closer to real-time, thereby to inform decisions that could impact the material flow. Alternatively, it would be desirable to provide a useful alternative to existing material flow interfaces.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY

In one aspect there is provided a computer implemented method for generating a deviation resource flow interface on a computer system display, the method comprising:

for planned flows of resources, obtaining information on planned transfers of one or more resources from one or more of a first set of nodes to one or more of a second set of nodes;

for actual flows of resources, obtaining information on performed transfers of at least some of the one or more resources from one or more of the first set of nodes to the one or more of the second set of nodes;

aggregating the information on the planned and performed transfers of resources and determining flow statuses for the aggregated resource transfers, wherein:
if it is determined that a planned transfer has not been performed, assigning to such planned unperformed transfer a flow status indicating a deviation from plan;
if it is determined that a performed transfer does not conform to a planned transfer, assigning to such performed transfer a flow status indicating a deviation from plan; and
if it is determined that a performed transfer conforms to a planned transfer, assigning to such performed planned transfer an on-plan flow status, and

receiving a deviation flow view selection through an input device; and

generating and displaying on the computer system display the aggregated planned and performed flows as a resource flow diagram, the resource flow diagram comprising one or more distinct weighted links between one or more of the first set of nodes and one or more of the second set of nodes, wherein each of the weighted links is indicative of resource flow with a flow status indicating whether the flow is a deviation from the planned transfers or not.

In accordance with a further aspect there is provided a computer system comprising: a processing unit; a display; and computer readable memory storing instructions which, when executed by said processing unit, cause said processing unit to perform a method as defined above.

According to yet another aspect there is provided a non-transient memory storing instructions executable by a computer processing unit to perform a method as defined above.

As used herein, except where the context requires otherwise, the term “comprise” and variations of the term, such as “comprising”, “comprises” and “comprised”, are not intended to exclude further additives, components, integers or steps.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

Illustrative embodiments of the various aspects of the present disclosure will now be described by way of non-limiting example only, with reference to the accompanying drawings. In the drawings:

FIG. 1 is a block diagram showing an example of a computer processing system;

FIG. 2 is an example planned resource flow interface in accordance with an embodiment;

FIG. 3 is an example performed resource flow interface in accordance with an embodiment;

FIG. 4 is another example performed resource flow interface, showing further details of flow between nodes, in accordance with an embodiment;

FIG. 5 is yet another example performed resource flow interface which is related to the planned resource flow interface of FIG. 2, in accordance with an embodiment;

FIG. 6 is an example deviation resource flow interface related to the planned resource flow interface of FIG. 2 and the performed resource flow interface of FIG. 5, in accordance with an embodiment; and

FIG. 7 is a flowchart that illustrates a method for generating a deviation resource flow interface in accordance with some embodiments.

### DETAILED DESCRIPTION

The present disclosure generally relates to systems and methods for generating and displaying various resource flow interfaces, in particular a deviation resource flow interface on a display of a computer system. As is described in detail below, the deviation resource flow interface allows for the viewing, and manipulation of resource information. In one example embodiment, also the embodiment described in detail, the disclosure relates to resource flow data in a mining environment, in particular the flow or transfer of materials, e.g., from excavation by pieces of mining equipment to destination locations such as off-loading sites, that may be processing plants or dumping sites.

Computer Processing System

The present disclosure is necessarily implemented using an electronic device. The electronic device is, or will include, a computer processing system.

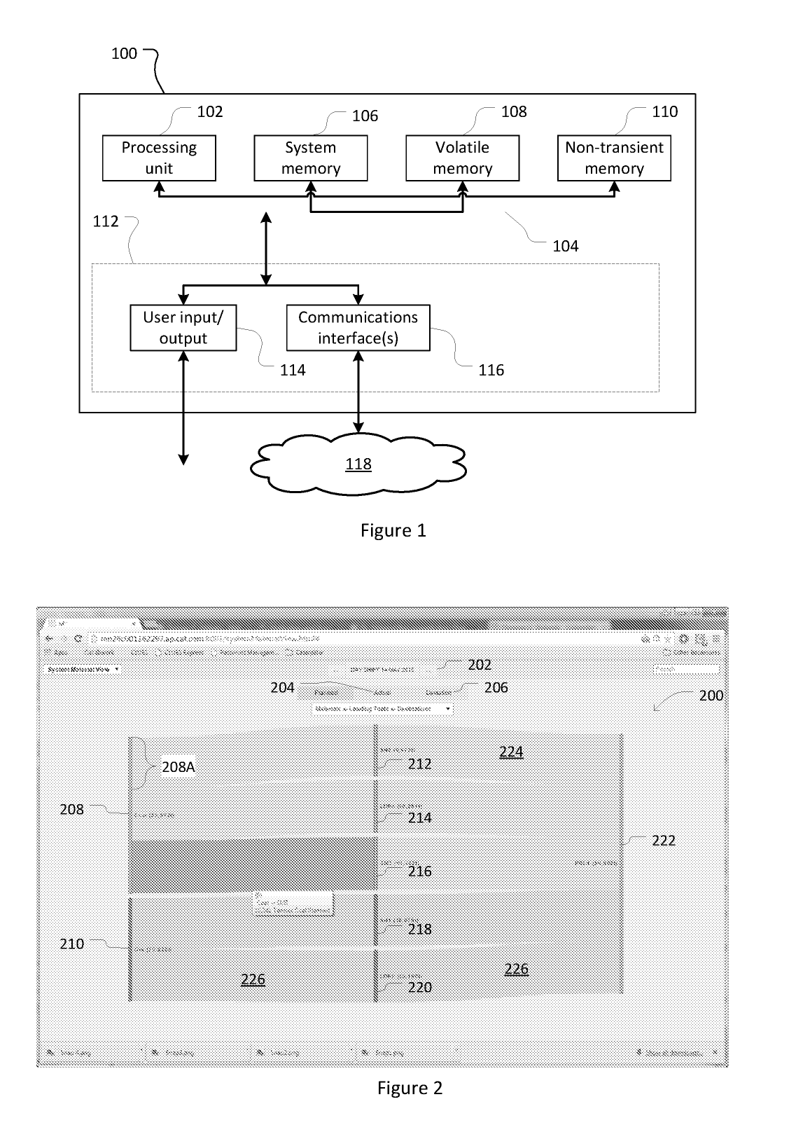

FIG. 1 provides a block diagram of one example of a computer processing system 100. System 100 as illustrated in FIG. 1 is a general-purpose computer processing system. It will be appreciated that FIG. 1 does not illustrate all functional or physical components of a computer processing system. For example, no power supply or power supply interface has been depicted, however system 100 will either carry a power supply or be configured for connection to a power supply (or both). It will also be appreciated that the particular type of computer processing system will determine the appropriate hardware and architecture, and alternative computer processing systems suitable for implementing aspects of the disclosure may have additional, alternative, or fewer components than those depicted, combine two or more components, and/or have a different configuration or arrangement of components.

The computer processing system 100 includes at least one processing unit 102. The processing unit 102 may be a single computer-processing device (e.g., a central processing unit, graphics processing unit, or other computational device), or may include a plurality of computer processing devices. In some instances, all processing will be performed by processing unit 102. However, in other instances processing may also, or alternatively, be performed by remote processing devices accessible and useable (either in a shared or dedicated manner) by the system 100.

Through a communications bus 104 the processing unit 102 is in data communication with a one or more machine-readable storage (memory) devices that store instructions and/or data for controlling operation of the processing system 100. In this instance, the system 100 includes a system memory 106 (e.g. a BIOS), volatile memory 108 (e.g., random access memory, such as one or more DRAM modules), and non-volatile memory 110 (e.g., one or more hard disk or solid state drives).

The system 100 also includes one or more interfaces, indicated generally by 112, via which the system 100 interfaces with various devices and/or networks. Generally speaking, other devices may be physically integrated with the system 100, or may be physically separate. Where a device is physically separate from the system 100, connection between the device and the system 100 may be via wired or wireless hardware and communication protocols, and may be a direct or an indirect (e.g. networked) connection.

Wired connection with other devices/networks may be by any appropriate standard or proprietary hardware and connectivity protocols. For example, the system 100 may be configured for wired connection with other devices/communications networks by one or more of: USB; FireWire; eSATA; Thunderbolt; Ethernet; OS/2; Parallel; Serial; HDMI; DVI; VGA; SCSI; AudioPort. Other wired connections are, of course, possible.

Wireless connection with other devices/networks may similarly be by any appropriate standard or proprietary hardware and communications protocols. For example, the system 100 may be configured for wireless connection with other devices/communications networks using one or more of: infrared; Bluetooth; Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are, of course, possible.

Generally speaking, the devices to which the system 100 connects—whether by wired or wireless means—allow data to be input into/received by the system 100 for processing by the processing unit 102, and data to be output by the system 100. Example devices are described below, however it will be appreciated that not all computer-processing systems will include all mentioned devices, and that additional and alternative devices to those mentioned may well be used.

For example, the system 100 may include or connect to one or more input devices by which information/data is input into (received by) the system 100. Such input devices may include physical buttons, alphanumeric input devices (e.g. keyboards), pointing devices (e.g. mice, track pads and the like), touchscreens, touchscreen displays, microphones, accelerometers, proximity sensors, GPS devices and the like. The system 100 may also include or connect to one or more output devices controlled by the system 100 to output information. Such output devices may include devices such as indicators (e.g., LED, LCD or other lights), displays (e.g., CRT displays, LCD displays, LED displays, plasma displays, touch screen displays), audio output devices such as speakers, vibration modules, and other output devices. The system 100 may also include or connect to devices which may act as both input and output devices, for example memory devices (hard drives, solid state drives, disk drives, compact flash cards, SD cards and the like) which the system 100 can read data from and/or write data to, and touch-screen displays which can both display (output) data and receive touch signals (input).

The system 100 may also connect to communications networks (e.g., the Internet, a local area network, a wide area network, a personal hotspot etc.) to communicate data to and receive data from networked devices, which may themselves be other computer processing systems.

It will be appreciated that the system 100 may be any suitable computer processing system such as, by way of non-limiting example, a desktop computer, a laptop computer, a netbook computer, tablet computer, a smart phone, a Personal Digital Assistant (PDA), a cellular telephone, a web appliance. Typically, the system 100 will include at least user input and output devices 114 and (if the system is to be networked) a communications interface 116 for communication with a network 118. The number and specific types of devices which the system 100 includes or connects to will depend on the particular type of system 100. For example, if the system 100 is a desktop computer, it will typically connect to physically separate devices such as (at least) a keyboard, a pointing device (e.g., a mouse), a display device (e.g., a LCD display). Alternatively, if the system 100 is a laptop computer, it will typically include (in a physically integrated manner) a keyboard, pointing device, a display device, and an audio output device. Further alternatively, if the system 100 is a tablet device or smartphone, it will typically include (in a physically integrated manner) a touchscreen display (providing both input means and display output means), an audio output device, and one or more physical buttons.

The system 100 stores or has access to instructions and data which, when processed by the processing unit 102, configure the system 100 to receive, process, and output data. Such instructions and data will typically include an operating system such as Microsoft Windows®, Apple OSX, Apple 105, Android, Unix, or Linux.

The system 100 also stores or has access to instructions and data (i.e. software) which, when processed by the processing unit 102, configure the system 100 to perform various computer-implemented processes/methods in accordance with embodiments (as described below). It will be appreciated that in some cases part or all of a given computer-implemented method will be performed by the system 100 itself, while in other cases processing may be performed by other devices in data communication with system 100.

Instructions and data are stored on a non-transient machine-readable medium accessible to the system 100. For example, instructions and data may be stored on the non-transient memory 110. Instructions may be transmitted to/received by the system 100 via a data signal in a transmission channel enabled (for example) by a wired or wireless network connection.

Flow View Interface

Planned Flow View Interface

FIG. 2 shows one example of a planned resource flow interface 200 for presentation on a display (such as a CRT display, LCD display, LED display, plasma display or touch screen display) of the computer system 100, in accordance with an embodiment. As already mentioned above, in this embodiment this and other interfaces are described with relation to its application in a mining environment, in particular in relation to the flow of resources i.e. mining materials from a number of a first set of nodes, e.g., pieces of mining equipment such as excavation vehicles to a number of second nodes, e.g., destinations or off-loading sites.

The planned resource flow interface 200 is depicted as a Sankey diagram. A Sankey diagram is a specific type of flow diagram that indicates particular flow quantities between various nodes, where the flow quantities are shown by weighted links between the nodes. The planned resource flow interface 200 is a flow view of planned transfers (i.e. targets for transfers) of various resources, in this example, mining materials, within a particular period of time. The period of time is shown here as a day shift on a specified day, namely 14 May 2015, as indicated by reference 202. For this period, a user may also select, through the use of soft buttons 204 and 206, a resource flow for actual (performed) transfers of materials (i.e. performed operations), or a resource flow for deviations between planned and performed transfer of materials. In this interface the “planned” soft button 207 is shaded to indicate that the planned resource flow interface is the currently active interface. The interface also provides a user to navigate to earlier or later shifts thereby to allow a user to conveniently view move between views of present and historical information. If navigation is to future dates, the interfaces may be restricted to planned resource flow interfaces only.

As mentioned, the resources in the embodiments herein describe relate to materials and in particular, mining materials planned to be excavated and excavated. These materials are shown in the interface 200 as coal 208 and ore 210. The coal 208 and ore 210 are to be excavated and then moved by various excavation equipment SH0, LDR4, SM3, SH1 and LDR2, represented by respective nodes 212 to 220, to an offloading destination, namely PRC1, shown by node 222.

For example, according to a mine plan, the excavation vehicle SHO 212 is to move coal 208A during the day shift of 14 May 2015 to a location PRC1 222. The excavation vehicle SH0 212 is to move 9,979 tonnes of coal. This planned flow is indicated by the weighted link 224 that connects the excavation vehicle SH0 212 node to the destination node PRC1 222. As is well-known with Sankey diagrams, the width of the link is representative of the amount of flow between the nodes. Similarly, the excavation vehicle LDR2 220 is planned to move 10,160 tonnes of ore to the off-loading site PRC1 222 during this same day shift, this transfer being indicated by the weighted flow 226.

The particular planned flow interface 200 shows the flow of material from resource (or category) nodes 208, 210, to excavation vehicle nodes 212 to 220 (also first set of nodes), to destination nodes 222 (second nodes). The resource nodes are informative as to the types of material excavated/moved by the various excavation vehicles represented by the many nodes of a first set.

It will be appreciated that the planned resource flow interface 200 may be adapted to show the sequence of flow in the order of excavation vehicle nodes, resource nodes and then location nodes.

Sankey diagrams of the planned resource interfaces typically represent planned (target) material movement as single volume blocks (or weighted link), for particular node to node combinations. It will be appreciated that this is typically the level at which planning will occur, i.e. prescribing an amount of tonnage of a particular material to be moved by a particular piece of excavation equipment to a defined destination.

Actual Resource Flow Interface

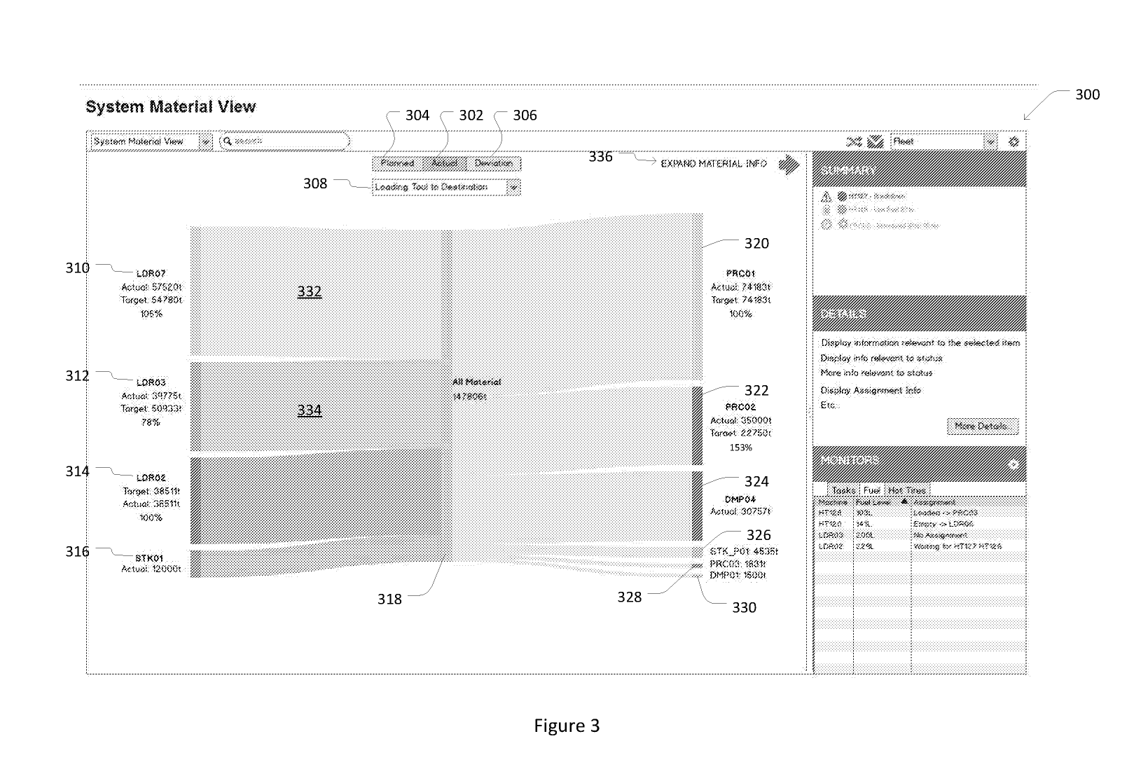

FIG. 3 shows one example of an actual (also performed) resource flow interface 300 that represents actual flow (i.e. performed and recorded flow) of materials within the mining environment.

The actual resource flow interface 300 is again depicted as a Sankey diagram and shows a flow of actual transfers of resources, in this embodiment, again mining materials. At the top of the interface a selected “actual” flow interface soft button 302 is shaded to show it as the selected option. For the relevant period, a user may alternatively select, through use of similar soft buttons 304 and 306, a resource flow interface for planned transfers of materials, or a resource flow interface indicating deviation between planned and actual transfers of materials. The particular actual view selected for this interface is “Loading tool to Destination”, indicated by reference numeral 308.

A number of first set of nodes are shown as excavation vehicles on the left hand side of the interface, namely LDR07 310, LDR03 312, LDR02 314 and STK01 316. For each excavation vehicle a value indicative of actual amount of materials moved, as well as planned (target) amount of materials to be moved is indicated next to the respective loading tool node 310, 312, 314 and 316. For example, according to a mining plan, loading tool LDR07 310 has a planned transfer of 54,780 tonnes of material during the period, while the actual amount of material transferred exceeded this amount by 5%, i.e. 57,520 tonnes of material was moved. This actual flow of material is shown by a weighted link 332. Similarly, the loading tool LDR03 312 only reached 78% of its planned or targeted value, with 79,775 tonnes of material moved, as opposed to 50,933 tonnes (shown by weighted link 334).

The flows from all the respective excavation vehicle nodes 310, 312, 314 and 316 are aggregated at an intermediate node 318, which indicates the total material excavated and transferred by all the indicated excavation vehicles to be 147,806 ton.

On the right hand side of the interface, a number of second nodes as destination sites are shown as PRC01 320, PRC02 322, DMP04 324, STK_P01 326, PRC03 328 and DMP01 330. This particular resource flow interface does not specify the material being excavated and transferred and also does not show the direct relation between the flow of material associated with a particular excavation vehicle and a particular destination.

Again, the actual amount of materials moved to the respective destination sites are indicated against planned (target) amount of moved material. For example, according to a mining plan, destination site PRC02 322 was to receive 22,750 tonnes of material during the particular period, while the actual amount of material off-loaded at the destination was 35,000 tonnes, with the destination accordingly being at 153% capacity.

These values of actual movements of material against values of planned (target) movements of material provide valuable information on the operations of the mine, which may inform an operator on problems to address or to avoid.

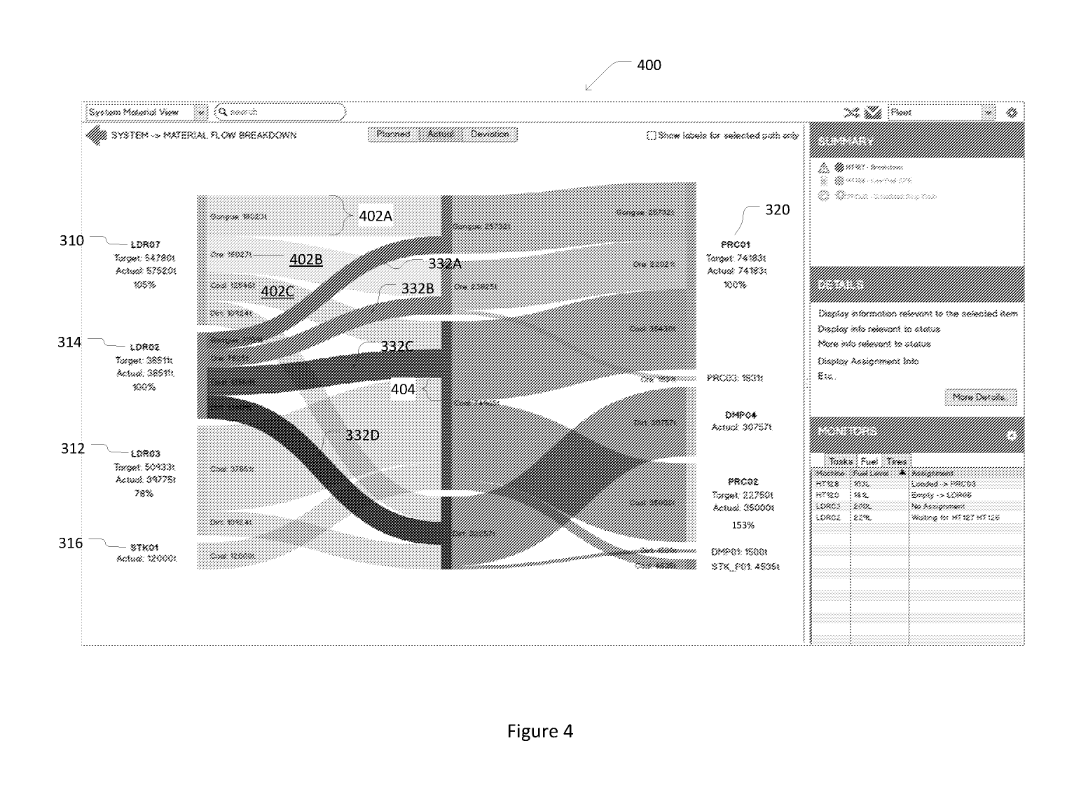

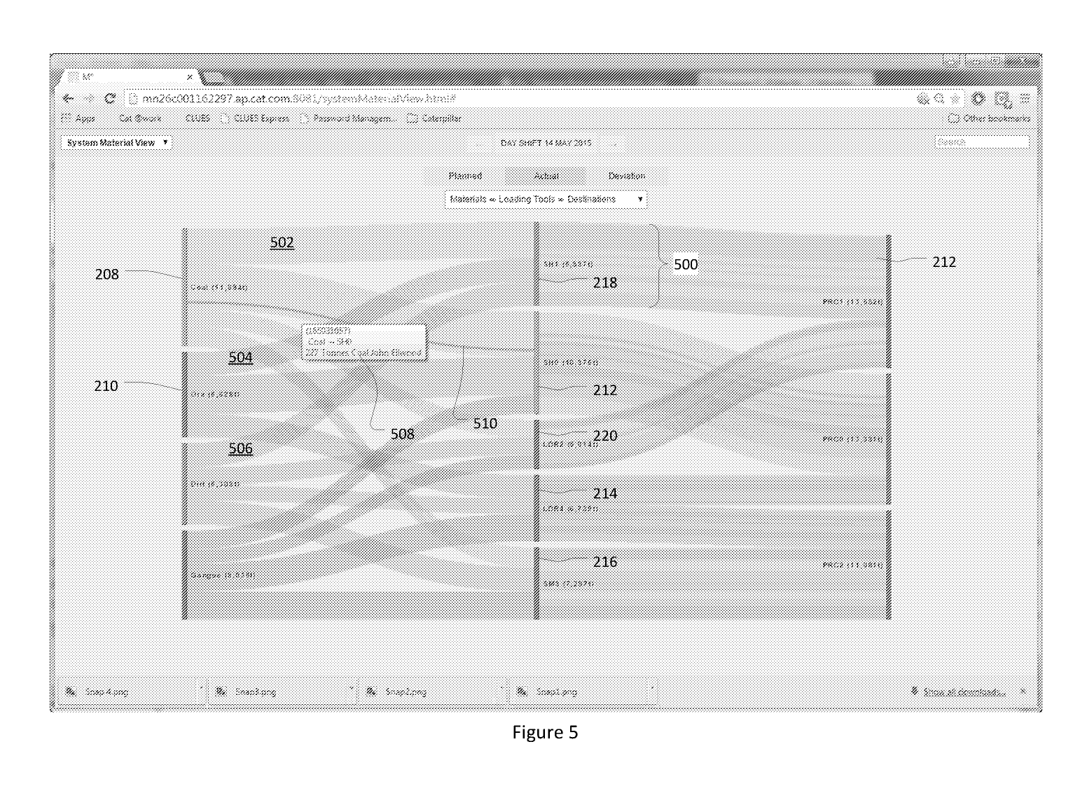

It will be appreciated that the information made available through the interface 300 is limited and that an operator may prefer to obtain more detailed information through an interface. In one example the interface 300 of FIG. 3 may be expanded upon by selecting the soft button “EXPAND MATERIAL INFO” 336 which then produces a more detailed actual resource flow interface 400, as shown by FIG. 4. As mentioned above, the same or similar features in the interfaces of FIGS. 3 and 4 will carry the same reference numerals. Implementation of the system and method may, in one embodiment, be restricted to the more detailed performed resource flow interface shown in FIG. 4 (or described in more detail below with reference to FIG. 5).

In this interface 400 which shows a material flow breakdown, the transfer or flow of different resources (i.e. categories of material) is shown from the respective excavation vehicle nodes to destination nodes. For example, the loading tool LDR02 312 is again shown as having moved 39,775 tonnes of material, but the material moved is indicated in FIG. 4 by respective flows shown by weighted links, in particular 7,709 tonnes of gangue (weighted link indicated by reference numeral 332A), 7,825 tonnes of ore (weighted link indicated by reference numeral reference 332B), 12,568 tonnes of coal (weighted link indicated by reference numeral 332C) and 10,409 tonnes of dirt (weighted link indicated by reference numeral 332D). FIG. 4 further shows that the flows of gangue 332A, ore 332B and coal 33C have all been transferred from excavation vehicle LDR02 312 to destination PRC01 320.

The flow of material to the destination PRC01 320 has other components and has thus additionally been made up of 18,023 tonnes of gangue, shown by 402A, 16,027 tonnes of ore 402B, shown by weighted link 402B, and 12,546 tonnes of coal, shown by 402C, and all excavated by excavation vehicle LDR07 310. Excavation vehicle LDR03 314 has also contributed 10,316 tonnes of coal to destination PRC01 320, indicated by portion 404.

FIG. 5 shows yet another actual (performed) resource flow interface, with this interface being related to the planned resource flow shown in accordance with FIG. 2. In fact, FIG. 5 shows the actual resource flows as performed by the excavation equipment of FIG. 2 for the same time period, i.e. the day shift on 14 May 2015.

With reference specifically to the excavations and transfers performed by excavation equipment SH1 218, this piece of equipment has excavated 8,537 tonnes of material indicated by weighted link 500. This material transfer is formed by contributions from coal (see weighted link 502), ore (see weighted link 504), and dirt (see weighted link 506). This Sankey diagram also indicates all contributions of material excavated by the various pieces of equipment to the destination PRC1, to which a total of 13,552 tonnes of material had been transferred by the point in time when the interface was generated.

In some example embodiments, and in contrast with the planned material flow diagram of FIG. 2, performed material flow may be represented in an initial view of the interface as what appears to be representative-sized blocks of flow (weighted links) between node. However, such flows (e.g., 502, 504 and 506) are aggregations or groupings of transfer cycles (i.e., specific deliveries or sub-groupings of deliveries), such as truck cycles resulting in the movement of material. As will be apparent from the description further below, information on such individual transfers is recorded and accessible by an operator of the system. For example, and as indicated by reference numeral 508, when an operator moves a mouse over a particular actual flow of material between nodes, the hovering mouse selects a particular individual truck cycle (see reference 510), which is highlighted. The user is then also provided with valuable information relating to the actual material movement of that cycle. For example, the information may include a batch number (i.e. 165031057), type of material moved (coal), excavation vehicle identifier (SH0), tonnage (227), vehicle operator (John Ellwood). This information is useful in the assessment of mining operations, and as this information is aggregated during the generation of deviation resource flow interfaces, would also be accessible in such interfaces.

Deviation Resource Flow Interface

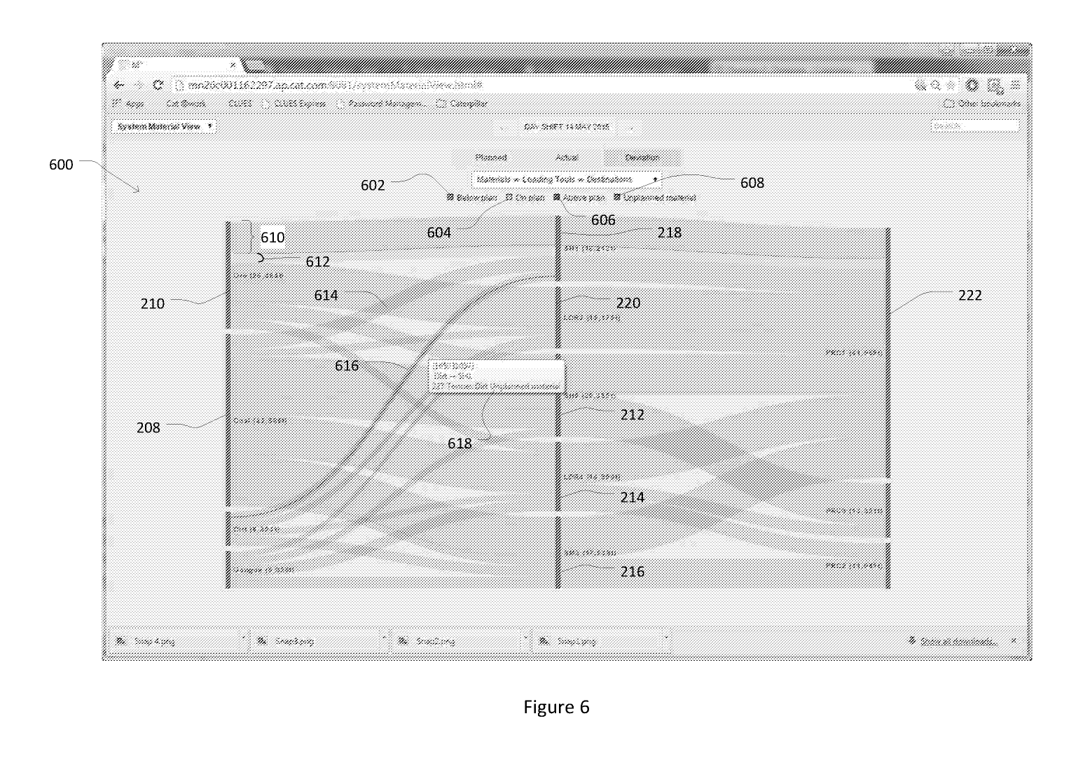

FIG. 6 shows a deviation resource flow interface 500 for the same mine environment and same period (14 May 2015 day shift) as shown in FIGS. 2 and 5. However, whereas FIG. 2 indicates the planned resource flows for various excavation vehicles 212 to 220, and FIG. 5 indicates actual resource flows for the excavation vehicles, FIG. 6 shows current (i.e. at the time of generating the interface) deviations between such planned resource flow, and the actual resources transferred. It will according be appreciated that the deviation resource flow interface represents a particular moment in time. As will become more apparent below, such deviation resource flow interfaces may be monitored by mining operators to get an understanding of the ongoing operations on the mine, to make changes in earlier plans and to deal with problems that may arise because of exceptions occurring during operations.

The deviation resource flow interface 500 shows the same resource nodes (ore 210 and coal 208), excavation vehicles (SH1 218, LDR2 220, SH0 212, LDR4 214 and SM3 216) as well as some destinations PRC1 222, as seen in FIGS. 2 and 5, although arrangements of the various nodes within each group may differ.

Different flows, shown as weighted links between the various nodes, make up the deviation resource flow interface 600. The presentation of the various flows as weighted links conform to a key indicative of the status of the flow, i.e. “Below plan” 502, “On plan” 504, “Above plan” 506 or “Unplanned material” 508. The deviation resource flow interface 600 accordingly gives an overview of the actual flow of material against a backdrop of what was planned. It also provides a visual presentation of planned and performed resource flows which assists any operators in addressing problems with mining operations.

For example, if it was planned that a particular excavation vehicle (such as SH1 218) would transfer ore 210 to a particular destination PRC1 222, e.g., from a particular excavation site of the ore, and it turns out that the excavation site is not only delivering ore but also coal and dirt, this exception will have an impact on the material flow. For example, and as shown in FIG. 6, the SH1 node is shown to include a “below plan” flow of ore, indicated by reference numeral 610, which is representative of 7,675 tonnes of ore not yet moved to destination PRC1 222. This particular resource flow may, in one embodiment, be indicated in red on the interface. Although these details are not shown on the interface of FIG. 6, an operator would have access to this information when a pointing device such as a mouse is hovered over the particular weighted link or resource flow described. The information on the underlying flows shown in the deviation resource flow interface are pulled through (during an information aggregation step) from the information recorded against either planned flows or performed flows.

An “on plan” portion of flow, indicated by reference numeral 612, shows the transfer of ore to the destination PRC1 222 by SH1 218, in accordance with planned resource flow for the period. In this scenario, and as will be described in more detail below, “on plan” typically means that the actual value transferred is within a tolerance of the plan/target for the shift, i.e. , it is in line with predetermined criteria set as part of the planned flow. This particular resource flow may, in one embodiment, be indicated in green on the interface.

Two streams of unplanned materials, see reference numerals 614 and 616, indicate that loading tool SH1 218 had to move additional and unplanned material (in the form of coal and dirt) to the destination PRC1 222. This may mean that the excavation site, in contrast with the mining plan, had delivered not only ore, but that coal and dirt were also located, which had to be excavated and moved by the particular excavation tool. Alternatively, it may mean that the excavation tool had to excavate at an unplanned location which resulted in the additional and unplanned material 614 and 616.

All the interfaces described above are adapted to allow additional information to be provided to a user when a pointing device, such as a mouse, is hovered over the weighted links between nodes (as already mentioned above). Examples of this are shown by reference numeral 508 in FIG. 5 and reference numeral 618 in FIG. 6. For example, in terms of the additional information shown by 618, batch number 165031057 is for movement of 227 tonnes of dirt by excavation vehicle SH1. It will be appreciated that the system could be configurable in terms of types of additional information made available through this drill-down functionality.

Although the interfaces, in particular the deviation resource flow interface of FIG. 6 above, are all shown as Sankey diagrams, it is appreciated that other suitable flow diagrams visually indicating the flow of a resource between different sets of nodes could be employed.

In terms of Sankey diagrams, the generation of such diagrams from data sources is well-known by those skilled in the art and more detailed information on their generation is accordingly not included in this disclosure.

Flow Interface Generation

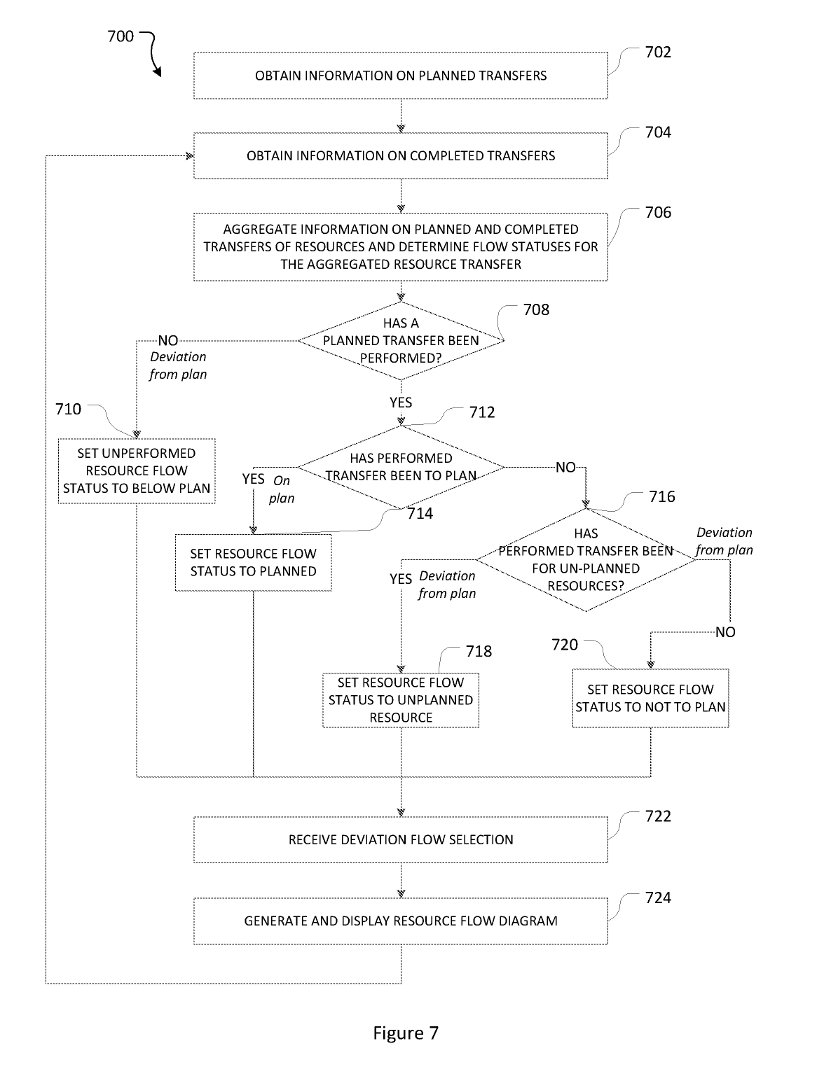

Referring to FIG. 7, a method 700 for generating a deviation flow interface such as interface 600 is depicted. The method 700 is implemented by a computer-processing unit 102 of the computer processing system 100. The computer-processing unit 102 is configured to perform the method 700 by use of computer readable instructions and data (i.e. software) stored in memory accessible by the computer-processing unit 102 (such as non-transient memory 110). In this case the system 100 displays information to the user on a display and user input is received from inputs made by the user either by entering information through the use of a pointing device and graphical user interface (i.e. through the use of soft buttons), or through a key board, or a combination of both. It will however be appreciated that the method 700 may alternatively be implemented on a device having a touchscreen display and that the user input may then be received from inputs made by the user either entering information on the touch screen display, physical buttons or a combination of both.

As will become apparent, information relating to both the planning of resource flows (e.g., operations on resources) as well as performed (i.e. actual) resource flows may also be obtained from a data store, where such information may have been stored as part of an operation plan, or as part of operational data recorded at various mining locations on an ongoing basis.

At 702 the computer system 100 obtains information relating to planned flows of resources between a number of a first set of nodes and a number of a second set of nodes.

In this embodiment, as in the disclosures of the interfaces, resources are various mining materials mined, excavated or moved within a mining environment. The first set of nodes represent pieces of mining equipment, e.g., excavation vehicles/tools such as shovels, loaders or the like that loads mining materials into transport vehicles. In this embodiment the second set of nodes represent destinations within the mining environment, e.g., various off-loading sites such as processing plants.

It will however be appreciated that resources may extend to any other categories of resources, e.g., any materials, components of articles/materials of the like, articles, entities, elements, costs/expenses, or energy. Nodes may indicate different operations, events or the like.

In some embodiments, the information on the planned flows or transfers may indicate groups of distinct and individual transfers of materials from a first set of nodes to a second set of nodes. Alternatively, or in addition, a bulk planned flow may be subdivided into multiple individual transfers of material. For example, the information on the planned flows may include multiple planned operations of a particular mining excavation tool to excavate a particular material and to effect its transfer to a processing site. Alternatively, the information on planned flows may describe the excavation of a particular area (i.e. a mining block) in a mining environment within a predetermined period of time, which excavation is broken down into more discrete flows to be performed during particular periods in order to excavate the entire planned area.

FIG. 2 shows a graphical representation of a planned resource flow in accordance with information recorded at 702. As already described, particular material is to be excavated by a particular machine and moved to a particular destination processing plant within a period of time.

At 704 the computer system 100 obtains information relating to actual flows of the materials, i.e. performed transfers of particular mining materials from a piece of excavation equipment to a destination. Actual flows thus relate to the performance of the planned flow, although in practice, exceptions (such as differences in the materials mined, or in the quality of the materials mined, breakdowns in equipment, etc) result in there being a difference between the planned mining activities and performed mining activities.

In a mining environment, records are kept of mining operations, in particular of materials excavated and transferred. For example, during excavation activities a particular excavation tool may excavate material, such as ore, from a particular area, with that material then being loaded into a truck. The truck transports the excavated material to a site, such as a processing or dumping site. At the point of off-load, the material is typically catalogued by assigning a batch number to the load, indicating the type of material included in the batch (e.g., ore, coal, gangue, dirt, etc), the time of day, an identifier of the truck (which may also be associated with a driver during the particular shift) and a site-identifier. It will be appreciated that other information may also be recorded. This information may be automatically or manually entered into the system thereby to keep proper records of all mining activities. It is also this information that are typically aggregated to determine progress of mining operations, in particular insofar as various materials have been excavated and transported. This may also be the type of detailed information to which user access is provided through the various resource flow interfaces, when a pointing device is hovered over a particular flow (e.g., shown by reference numeral 508 in FIG. 5 and reference numeral 618 in FIG. 6).

At 706 information on the planned and performed transfers of resources is aggregated. This aggregation is necessary in order to generate a deviation flow interface for the excavation activities of particular mining equipment in accordance with this disclosure (one example of which is shown in FIG. 6 described above). It is when the deviations between planned and actual (performed) resource transfers between nodes are tracked on a continuous basis that informed and intelligent decisions can be made by mining operators in order to better manage the excavation (operation) and flow.

As will be apparent from the description below, the aggregation of information on the planned and performed flows may be processed and presented in various ways. In one example embodiment, information may be processed only to show at a high level which transfers have been completed within predetermined parameters of a plan (i.e. transfers with, e.g., an “on plan” status), and in the alternative, which transfers occurred outside such predetermined plan (i.e. transfers with, e.g., an “deviation” status). In other embodiments, the deviations from plan may be determined to specified details, allowing the visual presentation of the various defined deviations in the deviation resource flow interface. A person skilled in the art will appreciate that such variations in aggregation and processing may require adaptations of information processing, characterising of particular flows and distinct presentations of flows. The variations may also be provided as different display options to be selected by a user.

In the example embodiment of FIG. 7, aggregation of information relating to the planned and performed transfers of resources are characterised, whereafter flow statuses are determined and assigned to the individual resource flows (or aggregated resource flows having similar characteristics) in accordance with predetermined criteria.

In this embodiment, at 708 and 710, planned transfers of material (e.g., a planned excavation of ore by a particular mining machine to be transferred to a loading site) which transfers have not been performed at the particular time, are assigned a status indicating a deviation from plan, such as a “below plan” status. Any other suitable label for this status may, of course, be provided, such as “still to process” or the like. Although steps 608 and 610 are shown as being performed once, it will be appreciated that these steps are to determine and assign labels to all resource flows that have been planned but not yet performed. This step may accordingly be iterative.

At 712 an assessment is made as to whether a performed (completed) transfer has been in accordance to the planned resource flow. For example, the completed transfer may be assessed against predetermined criteria of a planned resource flow, which criteria may include a time of day during which the transfer is to occur, a rate of transfer, a quality of resource etc. If the performed transfer is determined from the obtained information to be in accordance with a planned transfer flow, the performed transfer is assigned a status indicating that the transfer was in accordance with a planned flow, e.g., the status may be “on plan” or “planned” or the like (see 714). This status indicates that the particular mining flow operations are running smooth. See for example reference numeral 612 in FIG. 6.

At 716, a more detailed assessment is made on the performed, but not to plan, transfers. In particular, it is determined whether the transfers of material was for unplanned materials, in which case a suitable status is assigned to the transfer (at 718), e.g., “unplanned resource”. This will occur in instances where a planned flow stipulates the excavation of only particular resources, e.g., only ore, by a particular piece of equipment. However, during the operation, and due to an exception, the piece of equipment excavates ore, as well as coal and gangue. The coal and gangue flows will then be assigned an “unplanned resource” status. This is shown by reference numerals 614 and 616 in FIG. 6.

If it is determined in the alternative that the transfers of material was for not for unplanned materials, then, by default, all other performed transfers that are not according to plan, and that don't involve unplanned material (resources), necessarily relate to transfers which do not comply with the predetermined criteria of planned flows. At 720 a suitable status is then assigned to such flows, e.g., a status of “not-to-plan”.

A user interface typically includes various flow display options, e.g., a planned flow (see e.g., FIG. 2), a performed or actual flow (see e.g., any of FIGS. 3 to 5) and a deviation flow interface (see e.g., FIG. 6). In the event that a selection is received, e.g., via soft buttons such as shown by reference numeral 306 in FIG. 3, for the deviation flow (see 722), a deviation resource flow interface which shows at least some planned and unplanned flows is generated and displayed.

An example of such generated deviation resource flow interface is shown in FIG. 6. This interface, as described above, show groupings of planned and/or performed resource flows as weighted links between nodes, i.e. groupings of transfers of particular materials as excavated by a particular piece of mining equipment and then transported to some or other site. Each of the weighted links (i.e. a grouping of a particular planned and/or performed flow) that has a distinct status assigned to it is typically represented as visually distinct from other weighted links. Different flows may, e.g., be indicated in different colours, shading or patterns. This ensures that a user is able to easily and visually assess current deviations in a mining plan for a particular area, as the various statuses are indicative of deviations from plan. As individual flows carry particular information, a user is able to drill down into further details by moving a pointing device over the respective flows.

The deviation flow interface is generated at a particular point in time, at which point the performed flows are assessed against planned flows. E.g., if the deviation flow interface is generated at the end of a particular shift, a generated deviation flow interface will give details of the entire shift. However, if the interface is generated at a particular time during the shift, only the information currently available for performed flows would be taken into account.

The deviation flow interface in effect is to show the difference between a planned resource flow and actual resource flow.

It will be appreciated that the system and method may also generate and display flow interfaces for other nodes and resources. For example, drop-down lists may be presented to a user to configure elements of the flow in terms of the interface to be generated. Options include:
Loading tools (excavation equipment) to destinations;
Loading tools (excavation equipment) to destinations (including individual truck paths);
Area of excavation (mining blocks) to loading tools; and
Area of excavation (mining blocks) to loading tools (excavation equipment) to destinations.

Additional functionalities that may be provided by the interface are searching and filtering functionalities. In terms of searching, a user of the system may search for particular mining blocks, equipment and destinations. Filtering to limit the fleet may also be useful in limiting information presented through the interfaces.

The navigational functionality allowing a user to efficiently navigate through planned, performed or deviation resource flow interfaces of various shifts, current and historical may assist users of the system to better manage operational targets within mining plans and to make better informed decisions about the utilisation of equipment and flow of resources throughout the mining environment.

1. A computer implemented method for generating a deviation resource flow interface on a computer system display, the method comprising:
for planned flows of resources, obtaining information on planned transfers of one or more resources from one or more of a first set of nodes to one or more of a second set of nodes;
for actual flows of resources, obtaining information on performed transfers of at least some of the one or more resources from one or more of the first set of nodes to the one or more of the second set of nodes;
aggregating the information on the planned and performed transfers of resources and determining flow statuses for the aggregated resource transfers, wherein:
if it is determined that a planned transfer has not been performed, assigning to such planned unperformed transfer a flow status indicating a deviation from plan;
if it is determined that a performed transfer does not conform to a planned transfer, assigning to such performed transfer a flow status indicating a deviation from plan; and
if it is determined that a performed transfer conforms to a planned transfer, assigning to such performed planned transfer an on-plan flow status, and
receiving a deviation flow view selection through an input device; and
generating and displaying on the computer system display the aggregated planned and performed flows as a resource flow diagram, the resource flow diagram comprising one or more distinct weighted links between one or more of the first set of nodes and one or more of the second set of nodes, wherein each of the weighted links is indicative of resource flow with a flow status indicating whether the flow is a deviation from the planned transfers or not.

2. A computer implemented method of claim 1 wherein determining that the performed transfer has a deviation from plan flow status comprises determining that the performed transfer is a transfer of unplanned resources;
assigning to such performed transfer an unplanned resource flow status; and
displaying on the resource flow diagram the unplanned resource transfer as a distinct weighted link between nodes from the first and second sets of nodes.

3. A computer implemented method of claim 1 wherein determining that the performed transfer has a deviation from plan flow status comprises determining that the performed transfer is a transfer of planned resources which does not meet a predetermined criteria;
assigning to such performed transfer a not-to-plan flow status indicating that planned criteria was not met; and
displaying on the resource flow diagram the not-to-plan resource transfer as a distinct weighted link between nodes from the first and second sets of nodes.

4. A computer implemented method of claim 1 wherein determining that the performed transfer has a deviation from plan flow status comprises determining that the performed transfer is a transfer of planned resources which exceeds predetermined criteria;
assigning to such transfer an exceed plan flow status indicating that the planned criteria was exceeded; and
displaying on the resource flow diagram the exceed plan resource transfer as a distinct weighted link between nodes from the first and second sets of nodes.

5. A computer implemented method of claim 1 wherein the deviation from plan flow status for the unperformed transfer is a not-to-plan flow status indicating that the planned criteria was not met.

6. A computer implemented method of claim 1 wherein the resource flow diagram further comprises one or more weighted links extending from one or more resource nodes to one or more of the first set of nodes from which the flow of resources originate to the one or more of the second set of nodes where the resource flow terminates.

7. A computer implemented method of claim 1 wherein the resource flow diagram is a Sankey diagram indicating weighted links of the flow of resources with associated flow statuses between respective one or more of the first set of nodes to respective one or more of the second set of nodes.

8. A computer implemented method of claim 1 wherein, on selection of a displayed transfer flow, additional information associated with the transfer flow is displayed on the display screen.

9. A computer implemented method of claim 1 wherein information on performed transfers is obtained periodically from a data source.

10. A computer implemented method of claim 1 wherein information on performed transfers is obtained after a flow transfer has been recorded at the computer system or at a data store associated with the computer system.

11. A computer implemented method of claim 1 wherein each distinct weighted link between the one or more of the respective first and second sets of nodes is presented in a different colour, shading or ornamentation.

12. A computer implemented method of claim 1 wherein the resources are products mined within a mining environment.

13. A computer implemented method of claim 12 wherein each of the nodes of the first set of nodes represents a piece of mining equipment.

14. A computer implemented method of claim 12 wherein each of the nodes of the second set of nodes represents a destination of the mined products.

15. An computer system comprising:
a processing unit;
a display; and
computer readable memory storing instructions which, when executed by said processing unit, cause said processing unit to perform a method according to claims 1.

16. Non-transient memory storing instructions executable by a computer processing unit to perform a method according to claim 1.
